(19) United States
(12) Patent Application Publication
(10) Pub. No.: US 2009/0024708 A1
(43) Pub. Date: Jan. 22, 2009

(54) INSTANT MESSAGING IN A DATA PROCESSING SYSTEM

(75) Inventors: Barbara Febonio, Rome (IT); Sandro Piccinini, Rome (IT)

Correspondence Address: IBM Corp.;(Austin IP Law), c/o Johnson & Associates, P.O. Box 90698, Austin, TX, 78709-0698, US

(73) Assignee: INTERNATIONAL BUSINESS MACHINES CORPORATION, Armonk, NY (US)

(21) Appl. No.: 12/175,789

(22) Filed: Jul. 18, 2008

(30) Foreign Application Priority Data
Jul. 20, 2007 (FR) 07112816.9

(51) Int. Cl. G06F 15/16

(52) U.S. Cl. 709/206

(57) ABSTRACT

Methods, systems, and computer program products for exchanging instant messages among a plurality of users of data processing client entities (such as personal computers) are disclosed. For each user, a corresponding method starts with associating a profile with the user. The profile defines a set of (one or more) events, and for each event a set of (one or more) corresponding actions. The method continues by detecting the occurrence of one of the events. A selected action corresponding to the occurred event is then executed.

### CROSS REFERENCE TO RELATED APPLICATIONS

This application claims priority under 35 U.S.C. § 119 to commonly owned French patent application serial number 07112816.9 filed on Jul. 20, 2007, entitled “METHOD, SYSTEM AND COMPUTER PROGRAM FOR EXCHANGING INSTANT MESSAGES IN A DATA PROCESSING SYSTEM.”

### BACKGROUND

The present invention relates to the data processing field. More specifically, the present invention relates to the exchange of instant messages in a data processing system.

Instant messaging services have become very popular in recent years, particularly thanks to the widespread diffusion of global communication networks (such as the Internet). Instant messaging services allow a number of users to exchange instant messages (for example, short phrases of text) in real time. For this purpose, each user logs in the messaging service by means of a personal client computer (or simply client). The user can then send and receive the desired instant messages to and from other users through a server computer (or simply server) that offers the messaging service. This allows the users to exchange information in a direct and immediate way.

However, prior art messaging services are quite rudimentary. For example, typical prior art messaging services only provide very basic functions. Moreover, the available functions cannot be customized in desired ways by the users to fit personal and/or contingent needs.

### BRIEF SUMMARY

A method is provided for exchanging instant messages among a plurality of users, including associating a profile with a first user, the profile defining one or more events and one or more actions corresponding to the events, detecting the occurrence of one of the events, and executing an action corresponding to the detected event.

One embodiment may include a computer program product for exchanging instant messages among a plurality of users, including a computer-usable medium having computer usable program code embodied therewith, the computer usable program code including computer usable program code configured to associate a profile with a first user, the profile defining one or more events and one or more actions corresponding to the events, detect the occurrence of one of the events, and execute an action corresponding to the detected event.

One embodiment may provide an instant messaging system for exchanging instant messages among a plurality of users of data processing clients, including an editor for associating a profile with each user, each profile defining a set of events and for each event, a set of corresponding actions, a selector for detecting the occurrence of one of the events, and a controller for executing a selected action corresponding to the occurred event.

### BRIEF DESCRIPTION OF THE SEVERAL VIEWS OF THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1 is a schematic block diagram of a data processing system in which the solution according to an embodiment of the invention may be applied;

FIGS. 2-4 illustrate explanatory applications of the solution according to specific embodiments of the invention;

FIG. 5 shows software components that can be used to implement the solution according to an embodiment of the invention; and

FIG. 6 is a diagram describing the flow of activities relating to an implementation of the solution according to an embodiment of the invention.

### DETAILED DESCRIPTION

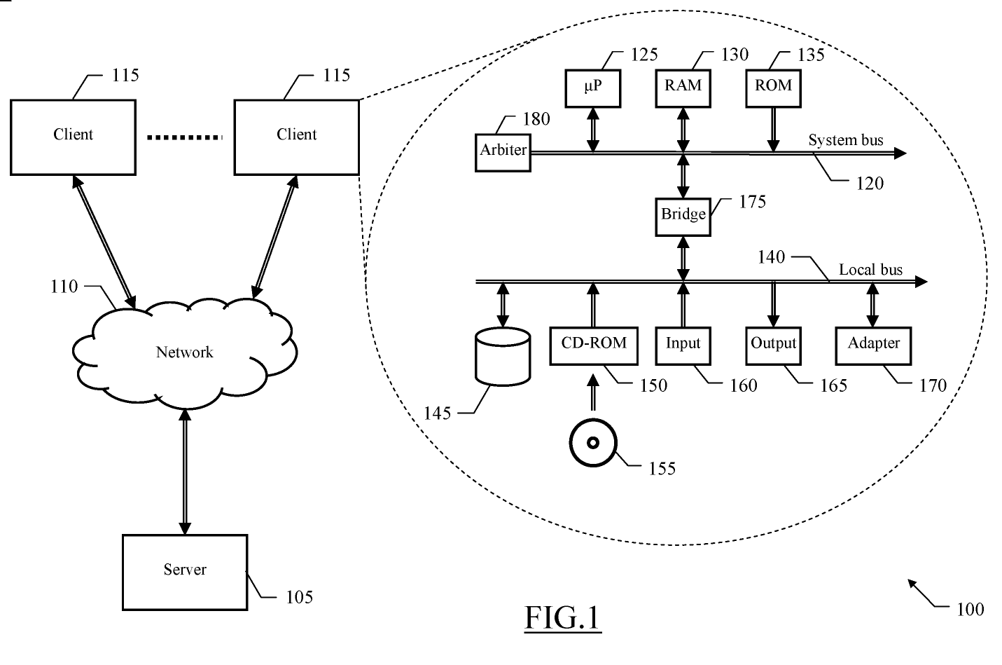

With reference in particular to FIG. 1, a distributed data processing system 100 is illustrated. The system 100 has a client/server architecture, typically based on the Internet. The Internet consists of millions of servers 105 (only one shown in the figure), which are interconnected through a global communication network 110. Each server 105 offers one or more services. Users of clients 115 access the server 105 (through computers—not shown in the figure—operating as access providers for the Internet), in order to exploit the offered service. In the specific case at issue, the server 105 provides an instant messaging service, which supports a number of real-time chats among different users, so as to allow them to exchange instant messages in real-time.

Particularly, each client 115 consists of a computer (such as a PC) that is formed by several units that are coupled in parallel to a system bus 120. In detail, a microprocessor (μP) 125 controls operation of the client 115. A RAM 130 is directly used as a working memory by the microprocessor 125, and a ROM 135 stores basic code for a bootstrap of the client 115. Several peripheral units are clustered around a local bus 140 (by means of respective interfaces). Particularly, a mass memory consists of a hard-disk 145 and a drive 150 for reading CD-ROMs 155. Moreover, the client 115 may include input units 160 (for example, a keyboard and a mouse), and output units 165 (for example, a monitor and a printer). An adapter 170 is used to coupled the client 115 to the network 110. A bridge unit 175 interfaces the system bus 120 with the local bus 140. The microprocessor 125 and the bridge unit 175 can operate as master agents requesting an access to the system bus 120 for transmitting information. An arbiter 180 manages the granting of the access with mutual exclusion to the system bus 120.

In the solution according to an embodiment of the invention, as described in detail below, a profile is associated with each user. The profile defines one or more events (such as the receipt of a message when the user is offline, the receipt of an inquiry for information about his/her status, the sending of a message to another user that is offline, and the like). For each event, the profile specifies one or more corresponding actions (such as the routing of the message to a different user, the logging of the message, the returning of customized status information, the retry of the sending of the message, and the like). Whenever one of the events (defined in the profile) is detected, a selected action corresponding to this event is executed.

The proposed solution strongly increases the flexibility of the messaging service. Particularly, this allows customizing the messaging service to fit personal and/or contingent needs of every user.

The aforementioned approach has a beneficial impact on the productivity of the users (for example, avoiding useless duplications of work). This reduces the workload of the server, and the traffic in the network (wherein the messaging service is implemented). All of the above improves the performance of the messaging service. Moreover, this reduces a congestion of the entire network (with positive side-effects on any other computer coupled thereto).

These advantages are clearly perceived in business applications (for example, in collaboration systems that are based on messaging services).

In a proposed implementation, each action is defined for a group of users. For example, the group may be specified either statically (by listing the desired users) or dynamically (by providing specific properties of the users, such as friends, colleagues, managers, clients, customers, and the like). At the opposed extremes, each group may consist of a single user or of all the users indiscriminately. Whenever the occurrence of an event is detected, the group to which the user associated with the event belongs is identified. The action corresponding to this group is then selected for its execution.

This additional feature makes it possible to customize the behavior of the messaging service for different users (either individually or in group).

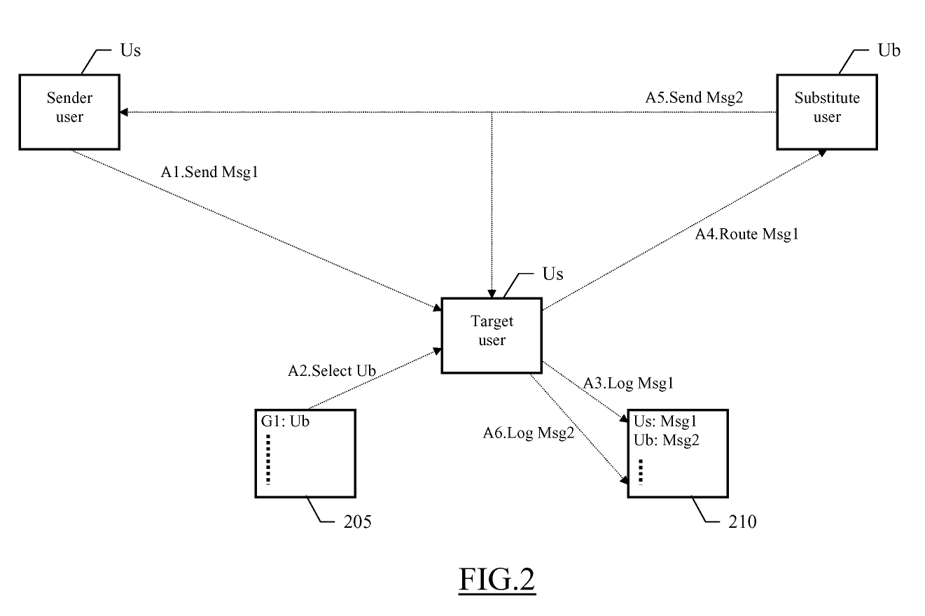

Exemplary applications of the above-described solution are illustrated in the collaboration diagrams of FIGS. 2-5, which show the dynamic behavior of the system by means of a series of actions (denoted with sequence numbers preceded by the symbol “A”).

With reference in particular to FIG. 2, let us consider a (source) user Us that sends a message Msg1 to a (target) user Ut that is offline (action “A1.Send Msg1”). The user Ut is associated with a profile 205, which specifies a substitute user Ub for a group G1 (to which the user Us belongs). When the user Ut receives the (incoming) message Msg1, s/he identifies the user Us from which the message Msg1 is received (for example, as indicated in its header). The user Ut selects the entry associated with the group of the user Us (i.e., G1) in the profile 205, and then extracts the substitute user (i.e., Ub) corresponding to this group G1 (action “A2.Select Ub”). At this point, the message Msg1 with an indication of the user Us is added to a log 210 (action “A3.Log Msg1”). At the same time, the message Msg1 is routed to the user Ub (action “A4.Route Msg1”). The message Msg1 may include an indication of both the user Ut (which sends it) and the user Us (on behalf of which it is sent).

In this way, when a target user cannot respond immediately to a message addressed to him/her, the same message is routed automatically to a substitute user that is capable of providing the desired response. This result is achieved without requiring any annoying and time consuming operation by the sender user. Moreover, the selection of the substitute user is performed directly by the target user, which is in the best position to determine the users being most suitable to provide the required response.

The user Ub may respond to the message Msg1. Typically, this operation is performed by replying automatically to all the users indicated in the message Msg1. In this way, a (response) massage Msg2 is sent both to the user Us and to the user Ut (action “A5.Send Msg2”). As above, the message Msg2 with an indication of the user Ub is added to the log 210 (action “A6.Log Msg2”). The same operations described above are repeated for any further message that is exchanged between the users Us and Ub.

In this way, when the user Ut returns online s/he can open the log 210 to display all the messages that have been received when s/he was offline. This provides a sort of memo function, which avoids any loss of information by the user Ut. In addition, the user Ut may also enters the conversation in progress between the users Us and Ub, so as to start a multi-part chat.

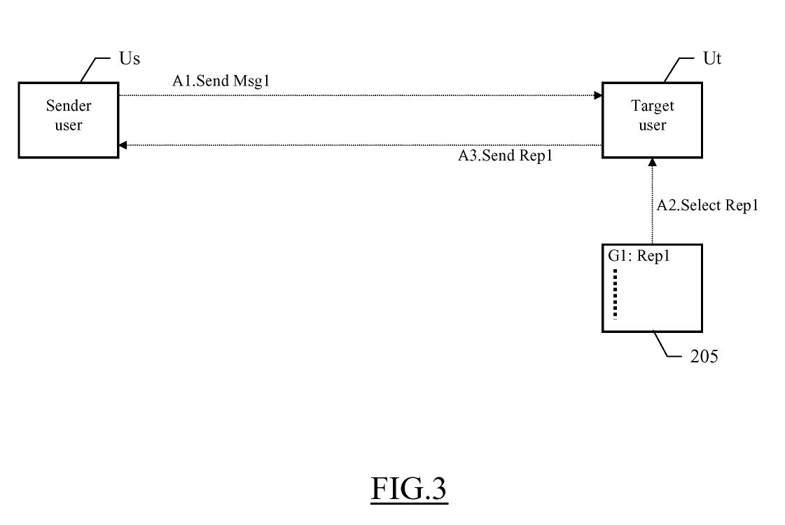

The FIG. 3 shows the same situation, wherein the user Us sends the message Msg1 to the user Ut that is offline (action “A1.Send Msg1”). In this case, however, the profile 205 of the user Ut specifies an (auto-reply) message Rep1 for the group G1 of the user Us. Therefore, when the user Ut receives the message Msg1 and identifies the user Us from which the message Msg1 is received, s/he selects the entry associated with the group of the user Us (i.e., G1) in the profile 205, and then extracts the message (i.e., Rep1) corresponding to this group G1 (action “A2.Select Rep1”). At this point, the message Rep1 is sent to the user Us (action “A3.Send Rep1”).

In this way, custom auto-reply messages can be defined for different users. For example, when a user is attending a meeting that was moved to a new room, s/he can define an auto-reply message with the indication of the new room for the other users that should attend the same meeting, and a standard auto-reply message with the indication of his/her unavailability for all the other users.

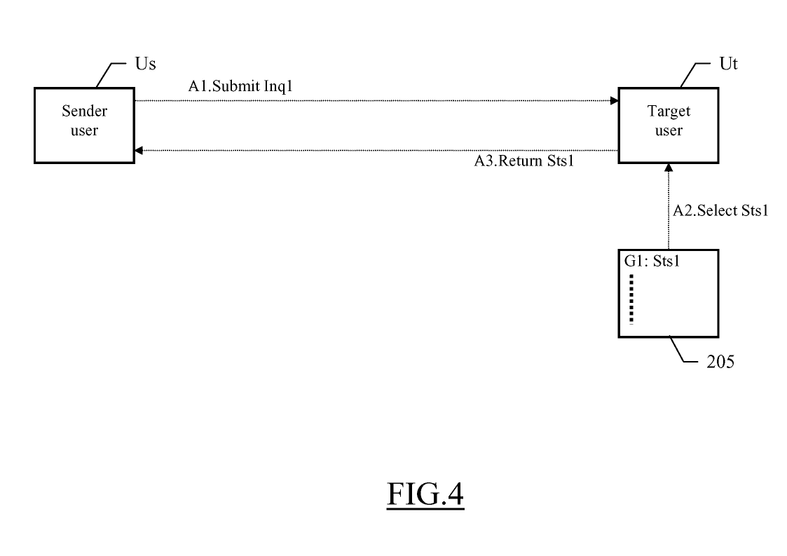

Another possible scenario is illustrated in FIG. 4. In this case, the user Us submits a (status) inquiry Inq1 to the user Ut, for retrieving information relating to his/her status (action “A1.Submit Inq1”). The profile 205 of the user Ut specifies a status label Sts1 for the group G1 of the user Us (for example, online, generically offline or more specifically busy, away, and the like). Therefore, when the user Ut receives the inquiry Inq1 and identifies the user Us from which the inquiry Inq1 is received, s/he selects the entry associated with the group of the user Us (i.e., G1) in the profile 205, and then extracts the status label (i.e., Sts1) corresponding to this group G1 (action “A2.Select Sts1”). At this point, the status label Sts1 is returned to the user Us (action “A3.Return Sts1”).

In this way, different status labels can be set for specific users. For example, a user may decide to be available only for his/her manager, but to appear as busy for any other user.

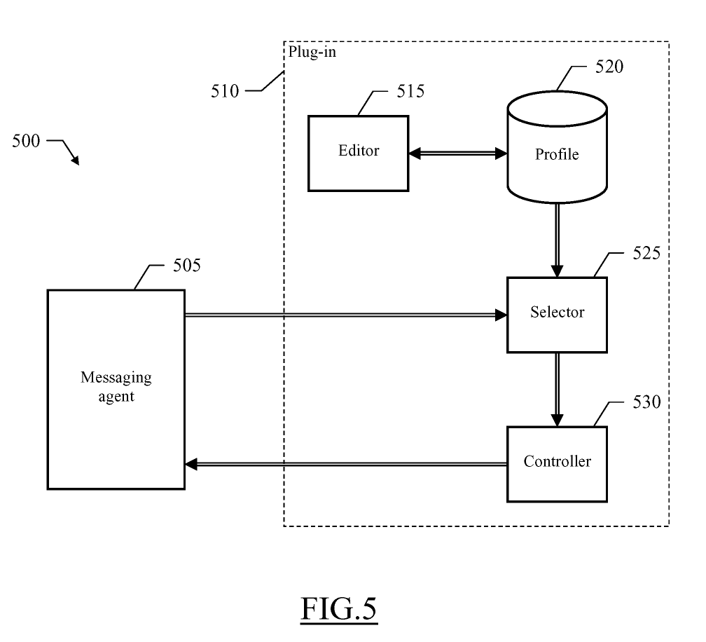

Moving to FIG. 5, the main software components that can be used to implement the above-described solution on a generic client are denoted as a whole with the reference 500. The information (programs and data) is typically stored on the hard-disk and loaded (at least partially) into the working memory of the client when the programs are running, together with an operating system and other application programs (not shown in the figure). The programs are initially installed onto the hard disk, for example, from CD-ROM.

Particularly, a messaging agent 505 (continuously running in the background) implements the client side of the messaging service. For this purpose, the messaging agent 505 downloads any incoming messages from and sends any outgoing messages to the server.

A plug-in module 510 implements the above-described solution. More in detail, the plug-in module 510 may include an editor 515 that is used to create, update and display the profile of the user working on the client. The profile is stored in a corresponding table 520 (under the control of the editor 515). Typically, the profile may include an entry for each event to be monitored. The entry specifies one or more actions to be executed for a corresponding group of users in response to the occurrence of the corresponding event. For example, the definition of the action may include an indication of one or more substitute users (for routing any incoming message being received when the user is offline), a memo flag (for logging any incoming message being received when the user is offline), an auto-reply message (to be sent in response to any incoming message being received when the user is offline), a status label (to be returned in response to any status inquiry), or a retry flag (to indicate the scheduling of the continual attempt to send an outgoing message to a target user being offline until s/he returns online).

A selector 525 interfaces with the messaging agent 505 to detect the occurrence of the events defined in the profile (for example, by means of a hooking technique). The selector 525 extracts an indication of the action corresponding to the group of the user associated with the occurred event from the profile (in the table 520). This information is passed to a controller 530. The controller 530 drives the messaging agent 505 to execute the desired action.

In this way, the new functionality provided by the proposed solution is implemented without requiring any modification to the server and/or to other (standard) clients.

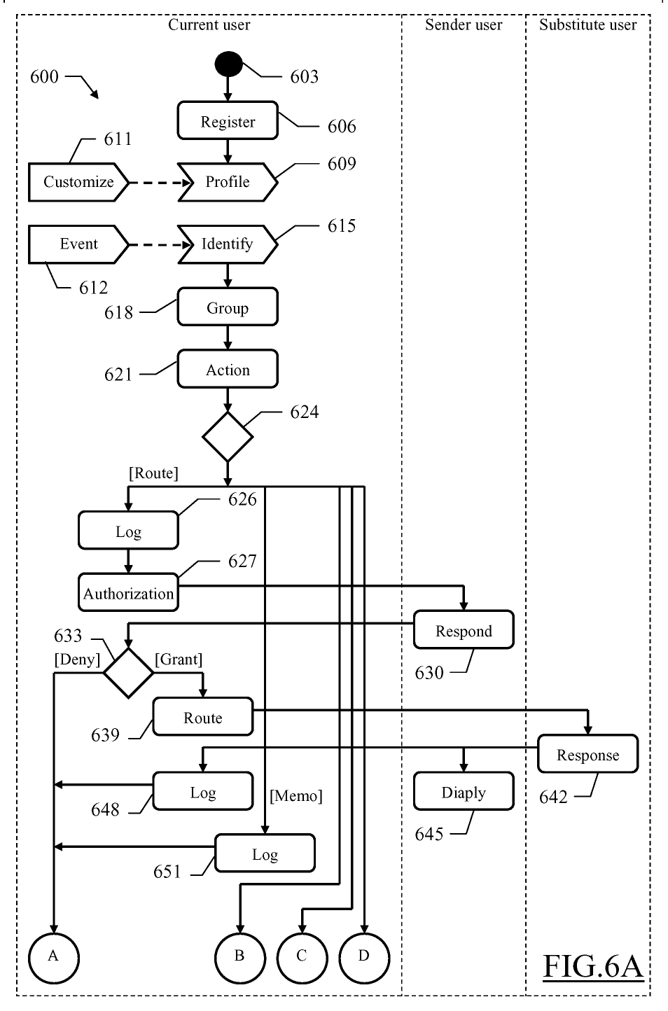

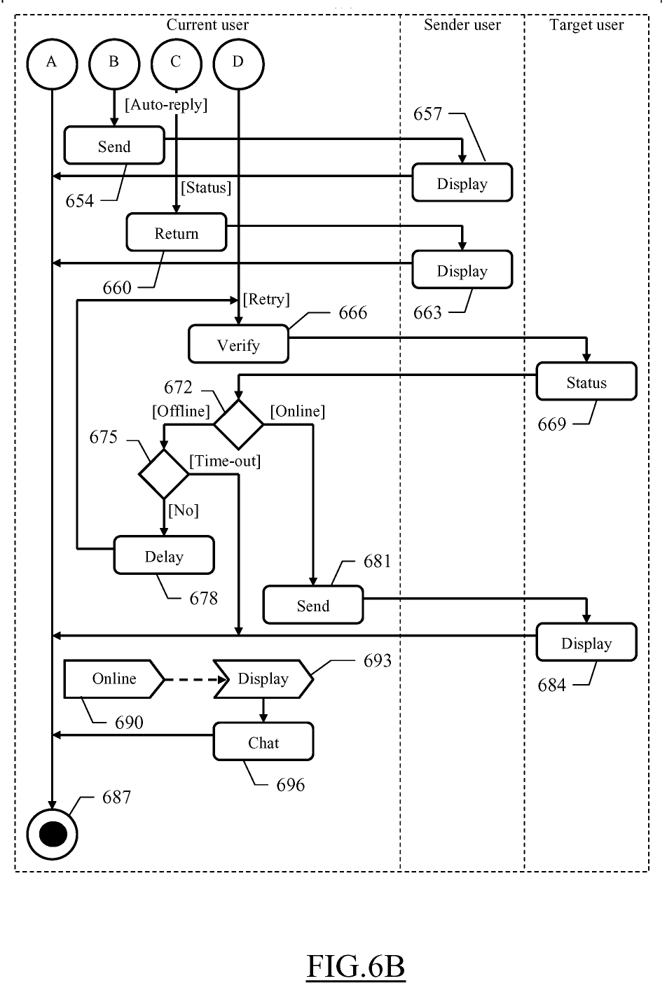

Considering now FIG. 6A-6B, the logic flow of an exemplary process that can be implemented in the above-described system (to manage the messaging service) is represented with a method 600. The method begins at the black start circle 603 in the swim-lane of a generic user. Continuing to block 606, the user registers to the messaging service (for example, by selecting a unique identifier and a password, and by entering personal information). The method then passes to block 609, wherein the user defines his/her profile (by specifying events with corresponding actions for specific groups of users). The same point is also reached asynchronously from block 611 whenever the user decides to update the profile.

As soon as an event defined in the profile is detected at block 612, the flow of activity proceeds to block 615. In this phase, the user associated with the event (i.e., the one from which an incoming message is received or to which an outgoing message is addressed) is identified. Descending into block 618, the group of this user is determined. The method then proceeds to block 621, where the action corresponding to the event for the group of the associated user is extracted from the profile.

The flow of activity branches at the decision block 624 according to the action to be executed. Particularly, if the incoming message is to be routed to a substitute user, the blocks 626-648 are executed. If the incoming message is to be logged, the block 651 is executed. If an auto-reply message is be sent the blocks 654-657 are executed. If a status label is to be returned the blocks 660-663 are executed. If the outgoing message is to be scheduled for retrying, its sending to a target user the blocks 666-678 are executed. In any case, the method then ends at the concentric white/black stop circles 687.

Particularly, the branch starting at the block 626 is entered when an incoming message is received from a sender user with the (current) user offline, and at the same time, the action for the group of the sender user specifies a corresponding substitute user. In this case, the incoming message is at first logged. Passing now to block 627, an authorization to route the incoming message is requested to the sender user. The sender user responds to the request at block 630 by granting or denying such authorization. Returning to the swim-lane of the current user, a test is made at block 633 to verify the received response. If the sender user denied the authorization to route the incoming message, the method descends into the stop circles 687 directly (without performing any further operation). This additional feature avoids any undesired dissemination of information (for example, of the personal or confidential type). Conversely, when the required authorization is granted the incoming message is routed to the substitute user (previously extracted from the profile) at block 639. The substitute user sends a response message at block 642 to both the sender user and the current user. The response message is displayed on the client of the (online) sender user as usual at block 645. The response message is instead simply logged on the client of the (offline) current user at block 648. The branch then ends at the stop circles 687.

Instead, the branch consisting of the block 651 is entered when an incoming message is received again from a sender user with the current user offline, and at the same time the action for the group of the sender user specifies an (asserted) memo flag. In this case, the incoming message is simply logged. The branch then ends at the stop circles 687.

The branch starting at the block 654 is entered when an incoming message is received from a sender user with the current user offline, and at the same time the action for the group of the sender user specifies a corresponding auto-reply message. In this case, the auto-reply message (previously extracted from the profile) is sent to the sender user. The auto-reply message is displayed on the client of the sender user as usual at block 657. The branch then ends at the stop circles 687.

The branch starting at the block 660 is entered when a status inquiry is received from a sender user, and at the same time the action for the group of the sender user specifies a corresponding status label. In this case, the status label (previously extracted from the profile) is returned to the sender user. The status label is displayed on the client of the sender user as usual at block 663. The branch then ends at the stop circles 687.

At the end, the branch starting at the block 666 is entered when an outgoing message is submitted by the current user for a target user that is offline, and at the same time the action for the group of the target user specifies an (asserted) retry flag. in this case, the availability of the target user is monitored by periodically submitting a corresponding inquiry. In response thereto, the target user at block 669 returns a status label indicative of his/her current status. Returning to the swim-lane of the current user, a test is made at block 672 to verify the received status label. If the status label indicates that the target user is still offline, the method checks at block 675 whether a time-out from the submission of the outgoing message (such as 10-120 min., for example) has been reached. If not, the method waits for a predefined delay at block 678 (such as 30-300 s, for example). The flow of activity then returns to block 666 to verify again the status of the target user. Conversely, once the time-out has expired the method descends into the stop circles 687 directly (without performing any further attempt to send the outgoing message). Referring back to block 672, as soon as the target user becomes online, the outgoing message is sent to him/her at block 681. The outgoing message is displayed on the client of the (online) target user as usual at block 684. The branch then ends at the stop circles 687.

Moving now to block 690, the user becomes online in a completely asynchronous way. In response thereto, all the logged messages (received when the user was offline) are displayed at block 693. The user may also decide at block 696 to start a multi-chat with the sender user and the substitute user. In any case, the method then ends at the stop circles 687.

Naturally, in order to satisfy local and specific requirements, a person skilled in the art may apply to the solution described above many logical and/or physical modifications and alterations. More specifically, although the present invention has been described with a certain degree of particularity with reference to preferred embodiment(s) thereof, it should be understood that various omissions, substitutions and changes in the form and details as well as other embodiments are possible. Particularly, the proposed solution may even be practiced without the specific details (such as the numerical examples) set forth in the preceding description to provide a more thorough understanding thereof. Conversely, well-known features may have been omitted or simplified in order not to obscure the description with unnecessary particulars. Moreover, it is expressly intended that specific elements and/or method steps described in connection with any disclosed embodiment of the invention may be incorporated in any other embodiment as a matter of general design choice.

Particularly, the proposed solution lends itself to be implemented with an equivalent method (by using similar steps, removing some steps being non-essential, or adding further optional steps). Moreover, the steps may be performed in a different order, concurrently or in an interleaved way (at least in part).

Similar considerations apply to equivalent instant messages (for example, including sounds, voices, static or moving images, and the like). Likewise, each user may consist of a single person or an alias for a group of persons. Moreover, the profile may be stored in an equivalent structure, or it may be defined with other formalisms (for example, with a file in the XML format). The proposed solution also lends itself to be implemented with other techniques for detecting the occurrence of the desired events (such as by wrapping the messaging agent with a custom module).

In any case, the events and/or the actions proposed above are merely illustrative, and they must not to be interpreted in a limiting manner. For example, it is possible to define any other number of events—down to a single one (for example, the receipt of messages including specific words). Likewise, it is possible to define any other number of actions for each event—down to a single one (for example, the sending of a warning in the form of an SMS to a mobile telephone of the user).

Alternatively, the groups of users may be specified with different criteria (for example, according to global definitions available on the server). In any case, the application of the proposed solution only at the level of individual users is not excluded.

Similar considerations apply if the profile specifies multiple substitute users for each group. For example, these substitute users may be exploited in decreasing order of preference for routing the incoming message (until one of them being online is found).

The feature of requesting the authorization to the sender user before routing the incoming message to the substitute user is not strictly necessary, and it may be omitted in basic environments (for example, based on a small private network).

Moreover, it is possible to condition the logging of the incoming messages that are routed to the substitute user (for example, by means of an additional flag in the profile), or even to skip this operation at all.

Nothing prevents only allowing the user to display the logged messages (without the possibility of starting any multi-part chat) when s/he returns online.

Similar considerations apply if the memo flag is replaced with any equivalent indicator in the profile.

As above, the auto-reply message as well may consist of any equivalent instant message.

The above-mentioned values of the status label are merely illustrative. For example, other values are envisaged (for example, sick, on vacation, and like).

Moreover, the monitoring of the target user (for sending any outgoing message addressed to him/her as soon as online) may be performed with other techniques (for example, with a different periodicity and even without any time-out).

Similar considerations apply if the program (which may be used to implement each embodiment of the invention) is structured in a different way, or if additional modules or functions are provided. Likewise, the memory structures may be of other types, or may be replaced with equivalent entities (not necessarily consisting of physical storage media). In any case, the program may take any form suitable to be used by or in connection with any data processing system, such as external or resident software, firmware, or microcode (either in object code or in source code—for example, to be compiled or interpreted).

Furthermore, embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

It is possible to provide the program on any computer-usable medium. The medium can be any element suitable to participate in containing, storing, communicating, propagating, or transferring the program. For example, the medium may be of the electronic, magnetic, optical, electromagnetic, infrared, or semiconductor type. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. In any case, the solution according to an embodiment of the present invention lends itself to be implemented with a hardware structure (for example, integrated in a chip of semiconductor material), or with a combination of software and hardware.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Although in the preceding description reference has been made to a local implementation of the proposed solution on each client, this is not to be intended as a limitation. Indeed, in a different embodiment of the invention the same solution may also be implemented centrally by the server that provides the messaging service (with a structure that it is more complex, but working even when the clients are off).

At the end, similar considerations apply to equivalent instant messaging services (for example, based on a mobile telephone infrastructure).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for exchanging instant messages among a plurality of users, the method comprising:
associating a profile with a first user, the profile defining one or more events and one or more actions corresponding to the events;
detecting an occurrence of one of the events; and
executing an action corresponding to the detected event.

2. The method of claim 1, wherein for at least one of the events, each action corresponding to the event relates to a corresponding group of users, and wherein the detected event originates from a second user, the method further comprising:
identifying a group to which the second user is associated, and
selecting the action corresponding to the identified group.

3. The method of claim 2, wherein the detected event relates to an incoming message from the second user addressed to the first user when the first user is not available, wherein the profile associated with the first user identifies at least one substitute user, the method further comprising routing the incoming message to the at least one substitute user.

4. The method of claim 3, wherein the incoming message is routed to the substitute user only if authorized by the second user.

5. The method of claim 3, further comprising logging the incoming message.

6. The method of claim 5, further comprising logging a message sent from the substitute user to the second user.

7. The method of claim 6, further comprising providing each logged message to the first user.

8. The method of claim 7, further comprising starting a multi-part chat conversation among the first user, the second user and the at least one substitute user, in response to the first user becoming available.

9. The method of claim 2, wherein the detected event relates to an incoming message from the second user addressed to the first user when the first user is not available, wherein the profile associated with the first user identifies at least one memo flag, the method further comprising:
logging the incoming message in response to the memo flag; and
in response to the first user becoming available, providing each logged incoming message to the first user.

10. The method of claim 2, wherein the detected event relates to an incoming message from the second user addressed to the first user when the first user is not available, wherein the profile associated with the first user includes an indication of an auto-reply message, the method further comprising sending the auto-reply message to the second user.

11. The method of claim 2, wherein the detected event relates to a status inquiry for information relating to a status of the first user, wherein the profile associated with the first user includes an indication of a status label, the method further comprising sending the status label to the second user.

12. The method of claim 2, wherein the detected event relates to an incoming message from the second user addressed to the first user when the first user is not available, wherein the profile associated with the first user includes an indication of a retry flag, the method further comprising sending the retry flag to the second user.

13. A computer program product for exchanging instant messages among a plurality of users, the computer program product comprising:
a computer-usable medium having computer usable program code embodied therewith, the computer usable program code comprising:
computer usable program code configured to associate a profile with a first user, the profile defining one or more events and one or more actions corresponding to the events, detect the occurrence of one of the events, and execute an action corresponding to the detected event.

14. An instant messaging system for exchanging instant messages among a plurality of users of data processing clients, the instant messaging system comprising:
an editor for associating a profile with each user, each profile defining a set of events and for each event, a set of corresponding actions;
a selector for detecting the occurrence of one of the events; and
a controller for executing a selected action corresponding to the detected event.

15. The system of claim 14, wherein an event detected by the selector relates to a message received by a first user from a second user when the first user is unavailable, wherein for at least one of the events, each action corresponding to the event relates to a corresponding group of users, and wherein the selector extracts an indication of an action corresponding to the group of the second user.

16. The system of claim 15, wherein the profile of the first user identifies at least one substitute user, and wherein the controller causes the message to be routed to the substitute user.

17. The system of claim 16, wherein the controller causes the message to be routed to the substitute user only when authorized by the second user.

18. The system of claim 16, wherein the substitute user replies to the second user, and wherein the controller causes the reply message to be logged.

19. The system of claim 15, wherein the controller causes the message to be logged.

20. The system of claim 19, wherein the controller causes the logged message to be provided to the first user when the first user becomes available.
